(19) United States
(12) Patent Application Publication
(10) Pub. No.: US 2023/0370267 A1
(43) Pub. Date: Nov. 16, 2023

(54) METHOD AND SYSTEM FOR TIME-CONTROLLED RELEASE OF AT LEAST ONE FUNCTION OF AN APPARATUS

(71) Applicant: Dr. Ing. h.c. F. Porsche Aktiengesellschaft, Stuttgart (DE)

(72) Inventor: Mark Foligno, Berlin (DE)

(73) Assignee: Dr. Ing. h.c. F. Porsche Aktiengesellschaft, Stuttgart (DE)

(21) Appl. No.: 18/133,101

(22) Filed: Apr. 11, 2023

(30) Foreign Application Priority Data
May 16, 2022 (DE) 10 2022 112 162.3

(51) Int. Cl. H04L 9/32; H04L 9/08

(52) U.S. Cl. CPC H04L 9/3213; H04L 9/083

(57) ABSTRACT

A method for time-controlled release of at least one function of an apparatus. The method includes providing a non-fungible token to a mobile device, wherein the non-fungible token contains key information for the time-controlled release of the function of an apparatus, extracting the key information from the provided non-fungible token by way of the mobile device, generating a digital key based on the extracted key information, transmitting the digital key from the mobile device to the apparatus, and checking the transmitted digital key by the apparatus. The function of the apparatus is released upon successful checking.

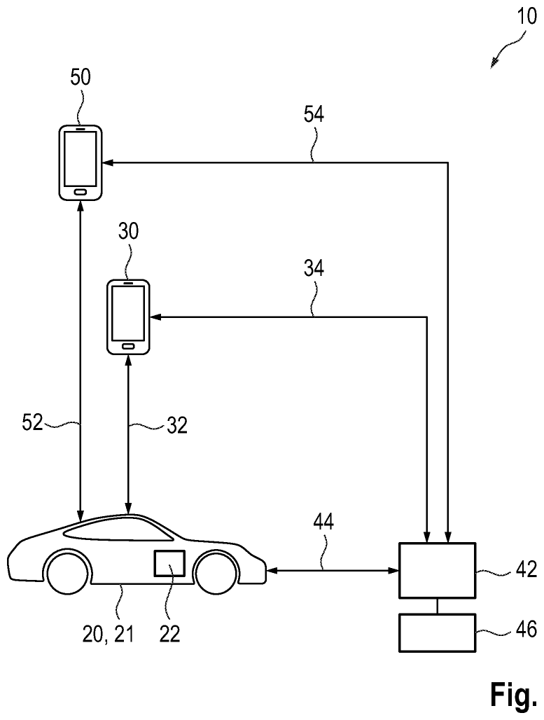

### CROSS-REFERENCE TO RELATED APPLICATION

This application claims priority to German Patent Application No. 10 2022 112 162.3, filed May 16, 2022, the content of such application being incorporated by reference herein in its entirety.

### FIELD OF THE INVENTION

The invention relates to a method and system for time-controlled release of at least one function of an apparatus, in particular a motor vehicle.

### BACKGROUND OF THE INVENTION

Mechanical car keys that are inserted into a lock for locking or opening a motor vehicle, as ignition keys for starting the engine, and for other functions, such as releasing a steering wheel lock in order to open or actuate the lock by rotation, are increasingly being replaced by wireless keys, wherein wireless keys can be used in order to lock and unlock the doors by remote control. Furthermore, so-called keyless locking systems allow a motor vehicle to be unlocked without active use of a car key when the key of the motor vehicle is detected in the immediate vicinity of the vehicle. Also, insertion of the key into an ignition lock is no longer required for the start of the motor vehicle. In all cases, physical keys are used.

Typically, a motor vehicle is used by a plurality of people, wherein each person typically carries his or her own physical key. With a large group of people using the motor vehicle, a high number of physical keys must exist, as a result of which the risk that one of the keys will be lost and the entire locking system will have to be replaced is relatively high. Otherwise, a few existing keys could be shared within the large group of people, which is laborious and impractical.

### SUMMARY OF THE INVENTION

Described herein is a method by which, in a simple and secure manner, multiple persons can use the apparatus.

First, a non-fungible token is provided to a mobile device. The non-fungible token is generated by a token generation system, for example a system provided by a vehicle manufacturer, and is a cryptographically unique, indivisible, irreplaceable, and verifiable token representing a particular object in a blockchain. The non-fungible token contains key information for time-controlled release of the function of an apparatus, wherein the key information is extracted from the provided non-fungible token using the mobile device, and a digital key is generated therefrom. The digital key is used in order to authenticate the user and contains information about the scope of the enabled functions. The digital key is transmitted from the mobile device to the apparatus and is checked by the apparatus. Here, the apparatus includes information for checking the validity of the digital key. The validity verification information of the digital key is provided to the apparatus from the token generation system, wherein the validity verification information is already provided to the apparatus prior to receiving the digital key. Upon successful verification of the digital key, the function of the apparatus is released.

In other words: The non-fungible token can be generated specifically for different individuals, wherein the individuals store the non-fungible token on their mobile device, in particular on their smartphone. If one of the functions of the apparatus is desired, key information is extracted from the non-fungible token stored on the mobile device, i.e., present in a so-called wallet, and a digital key is generated. The digital key, in turn, contains person-specific access rights to the apparatus or to the functions of the apparatus by the respective person. Finally, the transmitted digital key is checked for validity by the apparatus.

A time-controlled release of the apparatus is preferably understood to mean that the release of the function of the apparatus is limited to a particular time and/or period of time. For example, the owner of a motor vehicle could provide the motor vehicle to a third party for use, wherein the owner wishes to permit use during the day only. In this case, the owner of the motor vehicle would generate a non-fungible token for the third party such that, with the digital key resulting from the generated non-fungible token, only a release of a function of the motor vehicle, for example unlocking the vehicle doors, is exclusively possible between 8 a.m. and 8 p.m. The third party using the motor vehicle can load the non-fungible token onto his or her mobile device or the owner can send the non-fungible token applicable to the third party so that the third party can use the motor vehicle, i.e., unlock the vehicle doors and start the motor of the motor vehicle, but exclusively during the period of time specified by the owner. Otherwise, the owner could also release the use on a daily basis so that the third party can only use the vehicle on a weekend or for a single week from a predefined starting point.

Another use case is, for example, the use of time-controlled release of an entrance door of a building, wherein only access is released to a person during a predefined period of time.

By such a method, the use of an apparatus or the enablement of the release of functions of an apparatus by multiple people can be facilitated in a simple and secure manner, wherein only a non-fungible token must be generated by an instruction of an authorized person and another person must store the non-fungible token on his or her own mobile device. In addition, this controls in a simple way at what time and for what time period the respective persons can use the apparatus.

Preferably, the digital key is transmitted to the apparatus via a wireless connection. Thus, the mobile device serves as a wireless key, wherein an actual physical key is omitted. In a preferred configuration, the wireless connection is via NFC, RFID, or Bluetooth. In so doing, all types of near-field communication of the mobile device can be utilized without providing additional components on the mobile device, because communication apparatuses for NFC, Bluetooth and/or RFID are standard components of a mobile device, i.e., a smartphone.

Preferably, the mobile device is connected to a token generation system via a wireless connection, wherein the non-fungible token is generated by the token generation system using a blockchain network and transmitted to the mobile device. In so doing, the token generation system generates the non-fungible token using a blockchain network and sends it to the mobile device. The non-fungible token is stored on the mobile device and can be utilized to release the functions of the apparatus. Simultaneously, the token generation system also sends the information via a wireless connection to verify the validity of the digital key originating from the non-fungible token and transmitted from the mobile device to the apparatus.

In a particular configuration, the apparatus is a motor vehicle, wherein the functions are at least accessing the motor vehicle and driving the motor vehicle. Thus, the use of the motor vehicle by different persons can be enabled in a simple and secure manner, wherein the use of the motor vehicle can be precisely planned and controlled by the time-controlled release, so that it can be reliably avoided that several persons wish to use the motor vehicle at the same time.

Furthermore, different special functions of the motor vehicle can be released by the non-fungible token generated specifically for a person. For example, in the case of a rental vehicle, an additional use of a navigation system booked by the person can be enabled. Otherwise, for example, the performance of the motor vehicle can be reduced for certain people, so that these people can only drive at a reduced mileage, which thereby reduces the risk of an accident.

### BRIEF DESCRIPTION OF THE DRAWINGS

An exemplary embodiment of the invention will now be explained in further detail with reference to the FIGURE.

The FIGURE schematically shows a system for time-controlled release of at least one function of an apparatus.

### DETAILED DESCRIPTION OF THE INVENTION

The FIGURE shows a system 10 for the time-controlled release of functions of an apparatus 20, i.e., a motor vehicle 21.

The system 10 comprises a first mobile device 30 as well as a second mobile device 50. Both mobile devices 30, 50 are in particular smart phones and are owned by two different people or are used by two different people. The two mobile devices 30, 50 are used by way of example for a plurality of devices, wherein 5, 10, or 100 can also belong to the system 10.

The system 10 further comprises a token generation system 42 connected to a blockchain network 46 and a verification unit 22 associated with the motor vehicle 21.

The system 10 serves for a person-specific and time-controlled release of a plurality of functions of the motor vehicle 21. Upon successful release, at least the unlocking and locking of the vehicle doors and starting the engine of the motor vehicle 21 is possible. In addition, further person-specific functions of the motor vehicle 21 can be released.

In order to enable the release to different people in the first place, a separate, person-specific non-fungible token must first be generated for each person by a token generation system 42, which is a system provided by a vehicle manufacturer, for example. Subsequently, the generated non-fungible token is sent via a wireless connection 34, 54 to mobile devices 30, 50 as well as to the inspection unit 22 of the motor vehicle. The respective non-fungible token is stored on the mobile devices 30, 50 and can be utilized in order to release the functions of the motor vehicle 20. For this purpose, the non-fungible token contains key information that can be extracted from the non-fungible token by the mobile device 30, 50, i.e., by a corresponding function of the mobile devices 30, 50. From the key information, a personal digital key is generated by the mobile devices 30, 50, respectively. The digital key is used in order to authenticate the user. To bring about the use of the motor vehicle 21, the digital key is transmitted to the motor vehicle 21, i.e., to the verification unit 22, via a wireless connection 32, 52, in particular a Bluetooth or NFC connection, wherein the verification unit 22 checks the digital key for validity. The digital key can contain personal information stored therein about the scope of the release of the functions. Alternatively, the motor vehicle 21 can already comprise the information associated with the digital key regarding the scope of the release. To verify the digital key, the information transmitted by the token generation system 42 to the verification unit 22 and associated with the corresponding non-fungible token via a wireless connection 44 is used. Upon successful verification, the person can utilize the motor vehicle 21 to a predefined extent.

Thus, in a simple and secure manner, the use of the motor vehicle 21 by different persons can be enabled, wherein personal non-fungible tokens can be generated for any number of persons, and these can be used by the persons for the use of the motor vehicle 21.

A time-controlled release of the functions of the motor vehicle 21 is understood to mean that the release of the functions of the motor vehicle 21 is limited to a specific time and/or duration. In this case, the use of the motor vehicle 21 with a digital key resulting from the generated non-fungible token can be limited to a period of time between 8 a.m. and 8 p.m., for example.

The generation of the non-fungible token can be instructed by the person using the first mobile device 30 and authorized to generate such non-fungible tokens. To permit use of the motor vehicle 21 by the second mobile device 50, the mobile device 30 transmits the instruction to generate a new non-fungible token to the token generation system 42, wherein the token generation system 42 generates the new non-fungible token and transmits it to the second mobile device 50. At the same time, the information is transmitted to the verification unit 22 to verify the digital key associated with the newly generated non-fungible token.

Structural embodiments other than the described embodiments, which fall within the scope of protection of the main claim, are possible as well. In particular, the method is not limited to a motor vehicle and can, for example, also be used for an entrance door of a building or a bank lock box.

It is to be understood that the operational steps described herein are performed by the computer upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computer described herein is implemented in software code or instructions which are tangibly stored on a tangible computer readable medium. Upon loading and executing such software code or instructions by the computer, the computer may perform any of the functionality of the computer described herein, including any steps of the methods described herein. Each computer includes one or more of a processor, controller, and memory.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

What is claimed is:

1. A method for time-controlled release of at least one function of an apparatus, said method comprising:
providing a non-fungible token to a mobile device, wherein the non-fungible token contains key information for the time-controlled release of the function of the apparatus,
extracting the key information from the provided non-fungible token by way of the mobile device,
generating a digital key based on the extracted key information,
transmitting the digital key from the mobile device to the apparatus, and
checking the transmitted digital key by the apparatus, wherein the function of the apparatus is released upon successful checking.

2. The method according to claim 1, wherein the digital key is transmitted to the apparatus by a wireless connection.

3. The method according to claim 1, wherein the wireless connection occurs via NFC, RFID, or Bluetooth.

4. The method according to claim 1, wherein the mobile device is connected to a token generation system via a wireless connection, wherein the non-fungible token is generated by the token generation system using a blockchain network and transmitted to the mobile device.

5. The method according to claim 1, wherein the apparatus is a motor vehicle, and wherein the functions are at least providing access to the motor vehicle and driving the motor vehicle.

6. A system for time-controlled release of at least one function of an apparatus, the system being configured to:
provide a non-fungible token to a mobile device, wherein the non-fungible token contains key information for the time-controlled release of the function of the apparatus,
extract the key information from the provided non-fungible token by way of the mobile device,
generate a digital key based on the extracted key information,
transmit the digital key from the mobile device to the apparatus, and
check the transmitted digital key by the apparatus, wherein the function of the apparatus is released upon successful checking.
